(19) United States
(12) Patent Application Publication
(10) Pub. No.: US 2012/0089999 A1
(43) Pub. Date: Apr. 12, 2012

(54) Metadata Origination Verification

(75) Inventors: Wesley Wilcox, Addingham (GB); Neale Hall, Silsden (GB)

(73) Assignee: Eldon Technology Limited, Steeton (GB)

(21) Appl. No.: 12/902,969

(22) Filed: Oct. 12, 2010

(51) Int. Cl. H04N 7/167; H04N 7/16

(52) U.S. Cl. 725/31; 725/25

(57) ABSTRACT

One embodiment may take the form of a method for verifying metadata associated with programming content. The method may include receiving a first metadatum corresponding to a first programming content, comparing the first metadatum to a stored metadatum corresponding to the first programming content stored in a database, determining whether the first metadatum matches the stored metadatum, and transmitting a first signal if the first metadatum matches the stored metadatum and transmitting a second signal different from the first signal if the first metadatum does not match the stored metadatum.

### FIELD OF THE INVENTION

This disclosure relates generally to metadata verification, and more specifically to authenticated broadcasting of programming content utilizing metadata verification.

### SUMMARY

The present disclosure discusses systems and methods for metadata verification. In some embodiments, a verification server receives metadata corresponding to various programming content. The metadata may be compared to a database of metadata containing metadata corresponding to various upcoming or scheduled programming content to determine whether the received metadata matches the metadata corresponding to the upcoming or scheduled programming content. If the verification server determines that there is a match, the server may transmit an authentication signal to a programming receiver. If the verification server determines that there is not a match, the server may transmit a rejection signal to a programming receiver. The programming receiver may transmit the programming content to a broadcast receiver or prevent the transmission of the programming content to a broadcast receiver depending on whether an authentication or a rejection signal is received.

One embodiment may take the form of a method for verifying metadata associated with programming content. The method may include receiving a first metadatum corresponding to a first programming content, comparing the first metadatum to a stored metadatum corresponding to the first programming content stored in a database, determining whether the first metadatum matches the stored metadatum, and, transmitting a first signal if the first metadatum matches the stored metadatum, and transmitting a second signal different from the first signal if the first metadatum does not match the stored metadatum.

Another embodiment may take the form of a system configured to verify metadata associated with programming content. The system may include a server including a communication component operable to receive a first metadatum corresponding to a first programming content, a storage medium storing a database of at least one metadatum corresponding to at least one programming content, and a processing unit coupled to the storage medium and the communication component. The processing unit may be configured to access the database stored in the storage medium to determine whether the first metadatum matches at least one of the at least one programming content in the database.

Another embodiment may take the form of a method for authenticated broadcast of programming content. The method may include receiving a first programming content and a first metadatum corresponding to the first programming content, transmitting the first metadatum to a server, receiving a signal from the server, determining whether the received signal is a first type of signal or a second type of signal, and either transmitting the first programming content if the received signal is the first type of signal or preventing transmission of the first programming content if the received signal is the second type of signal.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a block diagram illustrating a system for authenticated broadcast transmission utilizing metadata verification.

FIG. 2 is a flow chart illustrating one embodiment of a method for metadata verification. This method may be performed by the system of FIG. 1.

FIG. 3 is a flow chart illustrating another embodiment of a method for metadata verification. This method may be performed by the system of FIG. 1.

### DETAILED DESCRIPTION OF THE EMBODIMENTS

The description that follows includes sample systems, methods, and computer program products that embody various elements of the present disclosure. However, it should be understood that the described disclosure may be practiced in a variety of forms in addition to those described herein.

Content creators or distributors may create metadata corresponding to programming content prior to transmission to a programming receiver for broadcast. For example, the metadata may include any type of non-displayed information relating to the programming content, such as the name of a program, the creator of the program, the camera lenses used to capture the program, the date on which the program was originally recorded, and so on and so forth. In some cases, other parties may intercept the programming content and associated metadata. These parties may create their own programming content and add to or edit the metadata corresponding to the intercepted programming content, making it difficult for the programming receiver to decipher the authenticity of the programming content.

The present disclosure discusses systems and methods for metadata verification. In some embodiments, a verification server receives metadata corresponding to various programming content. The metadata may be compared to a database containing metadata corresponding to various upcoming or scheduled programming content in order to determine whether the received metadata matches the metadata corresponding to the upcoming or scheduled programming content. If the verification server determines that there is a match, it may transmit an authentication signal to a programming receiver. However, if there is not a match, the server may transmit a rejection signal to the programming receiver. The programming receiver may transmit the programming content to a broadcast receiver or instead may prevent transmission of the programming content to a broadcast receiver depending on whether an authentication or a rejection signal is received.

Other embodiments may utilize various recognition algorithms for determining the authenticity of metadata. For example, some embodiments may utilize voice, scene, and/or facial recognition techniques to derive identifying information corresponding to the programming content, which may be compared to the metadata stored in the database.

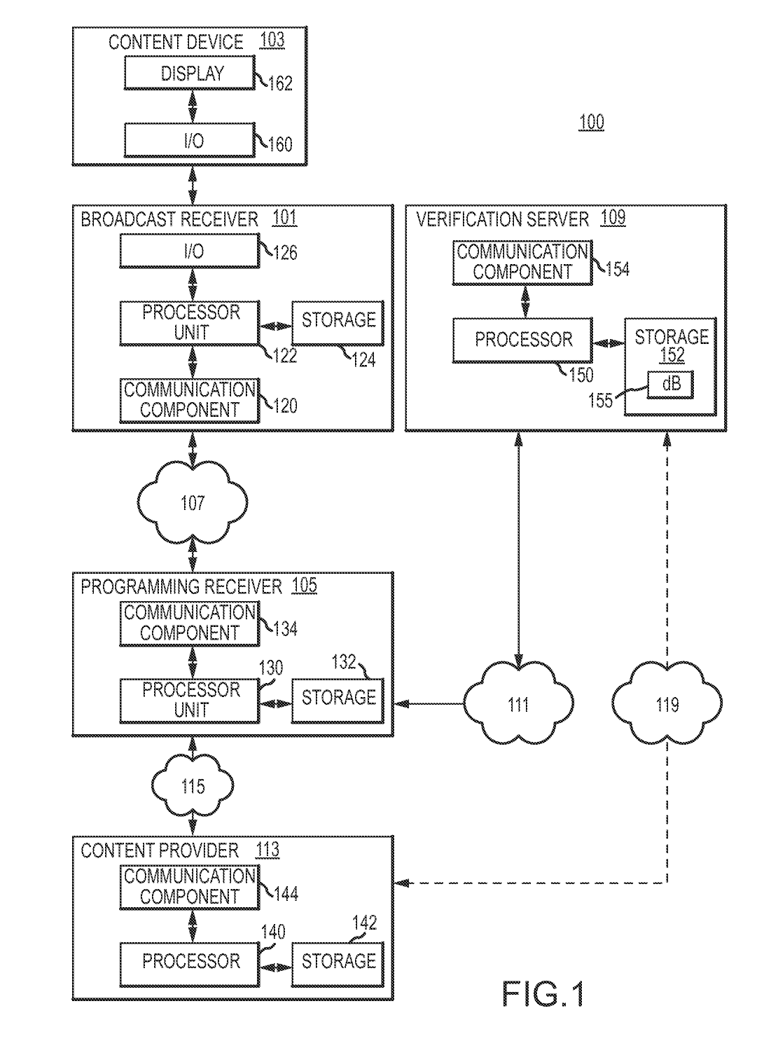

FIG. 1 is a block diagram illustrating a system for authenticated broadcast transmission utilizing metadata verification. As shown in FIG. 1, the system may include a broadcast receiver 101, a content device 103 communicatively coupled to the broadcast receiver 101, a programming receiver 105 communicatively coupled to the broadcast receiver 101 via one or more transmission media 107, and a verification server 109 communicatively coupled to the programming receiver 105 via one or more transmission media 111. The system may further include a content provider 113 that is communicatively coupled to the programming receiver 105 via one or more transmission media 115. “Transmission media,” as used herein, may include any kind of wired or wireless transmission media such as a satellite connection, an Internet connection, a cellular connection, a local area network connection, and so on.

The broadcast receiver 101 may include one or more processing units 122, one or more storage media (which may be any non-transitory machine-readable storage medium) 124, one or more communication components 120 configured to allow the broadcast receiver 101 to transmit and/or receive signals from the programming receiver 105, and one or more input/output components 126 configured to allow the broadcast receiver 101 to transmit and/or receive signals from the content device 103. The content device 103 may include one or more input/output components 160 and one or more display devices 162. The programming receiver 105 may include one or more processing units 130, one or more storage medium 132, and one or more communication components 134 configured to allow the programming receiver 105 to transmit and/or receive signals from the broadcast receiver 101, the content provider 113 and the verification server. The content provider 113 may include one or more processing units 140, one or more storage media 142, and/or one or more communication components 144 configured to allow the content provider 113 to transmit and/or receive signals from the programming receiver 105. The verification server 109 may include one or more processing units 150, one or more storage media 152, and one or more communication components 154 configured to allow the server 109 to transmit and/or receive signals from the programming receiver 105.

The broadcast receiver 101 may be a set top box, a cable box, a television receiver, a digital video recorder, a cellular telephone, a laptop computer, a desktop computer, a mobile computer, and so on. The broadcast receiver 101 may be operable to receive programming content (such as one or more television programs, movies, video on demand programs, images, audio, an so on) from one or more programming receivers 105 via one or more transmission media 107. The processing unit 122 of the broadcast receiver 101 may execute instructions stored in the storage medium 124 in order to store the received programming content in the storage medium, process the received programming content for display on an associated content device 103, and so on.

Each programming receiver 105, such as one or more satellite television providers, cable television providers, Internet service providers, video on demand providers, and so on, may receive programming content from one or more content providers 113 via one or more transmission media 115. The processing unit 130 of the programming receiver 105 may execute instructions stored in the storage medium 132 in order to transmit the programming content to the broadcast receiver 101. In one embodiment, the processing unit 130 may also execute instructions stored in the storage medium 132 in order to transmit metadata regarding upcoming programming content (which may be content that is scheduled to be broadcast, such as programs listed on an electronic program guide, special programming ordered by a user, and so on and so forth) to the verification server 109 via one or more transmission media 111. In other embodiments, the processing unit 130 may transmit the metadata as the programming content is being broadcast. As alluded to above, the metadata may include any type of metadata relating to the programming content, such as the name of a program, the creator of the program, the camera lenses used to capture the program, the date on which the program was originally recorded, and so on and so forth. The programming receiver 105 may receive the metadata (along with the programming content) from a content provider 113 via one or more transmission media 115. The content provider 113 may be the creator of the programming content or may be a distributor of the content, which may be created by another entity.

Upon receiving the metadata from the programming receiver 105, the processing unit 150 of the verification server 109 may execute instructions stored in the storage medium 152 to verify the authenticity of the received metadata. In one embodiment, this may be accomplished by comparing some or all of the received metadata with a database 155 of metadata stored in the storage medium. Alternatively, the processing unit 150 may retrieve the database of metadata from a remote database (not shown) utilizing the communication component 154. The database 155 of metadata may take the form of a relational database that links the programming content to its respective metadata. For example, the relational database may take the form of a tree, a look-up table, and so on and so forth.

If the processing unit 150 of the verification server 109 determines that the received metadata for the upcoming programming content matches the stored metadata in the database 155, the verification server may transmit an authentication signal to the programming receiver, signaling that the received metadata for the programming content has been verified. Alternatively, if the processing unit 150 determines that the received metadata does not match the stored metadata, the verification server may transmit a rejection signal to the programming receiver, signaling that the received metadata for the programming content is unverified or unauthentic. In other words, the processing unit 150 may determine that the received programming content is not the intended upcoming programming content, and should not be displayed to a viewer. The rejection and/or authentication signal may take the form of a digital or an analog signal.

Upon receipt of an authentication signal from the verification server 109, the programming receiver 105 may transmit the programming content associated with the verified metadata to the broadcast receiver 101 via the one or more transmission media 107. By contrast, upon receipt of a rejection signal, the programming receiver may block the programming content associated with the unverified metadata from being transmitted to the programming receiver 105. In one embodiment, the programming receiver 105 may be configured to block any programming content associated with unverified metadata, and to broadcast only content that is associated with verified metadata. In other embodiments, the programming receiver 105 may only block some of the programming content associated with unverified metadata. The broadcast receiver 101 may transmit the verified programming content to the content device 103, which, as alluded to above, may include a display 162 configured to display the programming content to a user.

In one embodiment, the verification server 109 may transmit a rejection signal if all of the received metadata does not match the stored metadata. However, in other embodiments, the verification 109 may transmit a rejection signal if a majority of the received metadata does not match the stored metadata. For example, the server 109 may transmit the rejection signal if 50% or more of the metadata does not match the stored metadata. In another embodiment, the server 109 may transmit the authentication signal if some of the metadata matches the stored metadata. For example, the verification server 109 transmit an authentication signal if some of the metadata matches the stored metadata, while some of the metadata does not match the stored metadata. Alternatively, the verification server 109 may only compare some of the metadata received from the programming receiver 105, and transmit an authentication signal if the metadata matches the stored metadata.

In other embodiments, the functions performed by the verification server 109 described above may be performed by a processing unit 130 of the programming receiver 105, or by the processing unit 122 of the broadcast receiver 101, as opposed to the verification server 109. For example, the processing unit 130 of the programming receiver 105 may execute instructions stored in the storage medium 124 to verify the authenticity of the metadata, and may transmit or not transmit programming content to the broadcast receiver 101 based on the authenticity of the metadata. Accordingly, some embodiments of the system 100 may not include a verification server 109. Additionally, in some embodiments, the verification server 109 may transmit the authentication or rejection signal to the broadcast receiver 101, as opposed to the programming receiver 105. In another embodiment, shown in FIG. 1, the content provider 113, as opposed to the programming receiver 105 may transmit the metadata for the upcoming programming content to the verification server 109 via one or more transmission media 119.

In one embodiment, the verification server 109 may use image, video, and/or audio recognition algorithms to verify the authenticity of the metadata received from the programming receiver 105. In this embodiment, the processing unit 150 of the programming receiver 105 (or the processing unit 140 of the content provider 113) may execute instructions stored in the storage medium to transmit the programming content to the verification server 109. Additionally, the processing unit 150 of the verification server 109 may execute an image, video and/or audio recognition algorithm stored in the storage medium 152 to perform image, video, and/or audio recognition on the programming content received from the programming receiver 105 (or the content provider 113) to derive identifying information for the programming content. As an example, in one embodiment, the processing unit 150 may be configured to perform facial or voice recognition on people captured in the programming content. As another example, the processing unit 150 may be configured to perform scene recognition on various scenes captured in the programming content to identify the recognized scene.

The processing unit 150 of the verification server 109 may compare the identifying information derived from the recognition algorithm to the database 155 of metadata stored in the storage medium 152. For purposes of illustration only, the identifying information derived from a facial recognition algorithm may be the identity of an individual. Similarly, the identifying information derived from a voice recognition algorithm may also be the identity of a speaker and/or decipher the words spoken by the speaker. The processing unit 150 of the verification server 109 may execute instructions to compare the identifying information to the database 155 of metadata in the storage medium 152, which, as alluded to above, may be provided in the verification server 109 or an external storage medium. If the identifying information from the recognition algorithm matches the metadata for the upcoming programming content in the database 155, then the processing unit 150 of the verification server 109 may determine that the metadata is authentic. In contrast, if the identifying information from the recognition algorithm does not match the metadata for the upcoming programming content in the database 155, then the processing unit of the verification server 109 may determine that the metadata is not authentic.

As discussed above, the verification server 109 may transmit an authentication signal to the programming receiver 105, signaling that the metadata for the received programming content has been verified, or, alternatively, may transmit a rejection signal signaling that the metadata is not authentic. Upon receipt of an authentication signal, the programming receiver 105 may transmit the programming content associated with the verified metadata to the broadcast receiver 101 via one or more transmission media 107. In contrast, upon receipt of a rejection signal, the programming receiver 105 may prevent the transmission of the programming content associated with the unverified metadata to the broadcast receiver 101.

In another embodiment, the programming content, as transmitted by the content provider 113, may be encrypted with the metadata by the content provider prior to transmission to the programming receiver. This may prevent, for example, interception or forgery of the metadata by a third party prior to transmission of the metadata to the verification server 109. In this embodiment, the processing unit 140 of the content provider 113 may execute instructions stored in the storage medium to encrypt the metadata into the signal containing the programming content. As an example, the content provider 113 may encrypt the signal every “n” number of seconds or scenes, during some other interval, or before or after the programming content is transmitted. The processing unit 140 of the content provider 113 may use various cryptographic algorithms, such as digital signature schemes, message authentication codes, and so on, to encrypt the metadata into the programming content signal. The encrypted programming content signal may be, for example, an audio-visual signal, an audio signal, a video signal, a digital data signal, an analog signal, and so on and so forth. The processing unit 140 may further execute instructions in the storage medium in order to transmit the programming content, with the encrypted metadata, to the verification server 109.

The processing unit 150 of the verification server 109 may execute instructions stored in the storage medium to decrypt the encrypted programming content signal to derive the corresponding metadata. In one embodiment, the verification server 109 may utilize a key for decrypting the encrypted programming content signal. The processing unit 150 may then determine whether the metadata corresponds to the metadata of the upcoming programming content. As discussed above, this may be accomplished by comparing some or all of the metadata to the metadata for the upcoming programming content stored in the database 155. If the processing unit 150 determines that the metadata matches the metadata stored in the database 155, then the verification server 109 may transmit an authentication signal to the programming receiver 105. In contrast, if the processing unit 150 determines that the metadata does not match the metadata stored in the database, the verification server 109 may transmit a rejection signal to the programming receiver 105. Additionally, the programming receiver 105 may transmit or withhold the programming content from the broadcast receiver 101, which may be configured to display the content on an associated content device 103.

In one embodiment, the programming receiver 105 may be a content-sharing website that allows users to upload, share, and access programming content, the transmission media 107 between the programming receiver 105 and the broadcast receiver 101 may be the World Wide Web, and the broadcast receiver 101 may be a network interface controller. In another embodiment, the programming receiver 105 may be a television provider, such as a satellite television provider, a cable television provider, and so on, and the broadcast receiver 101 may be a set-top box. Other embodiments may include other forms of programming receivers 105, transmission media 107, and/or broadcast receivers 101, as will be appreciated by one of ordinary skill in the art.

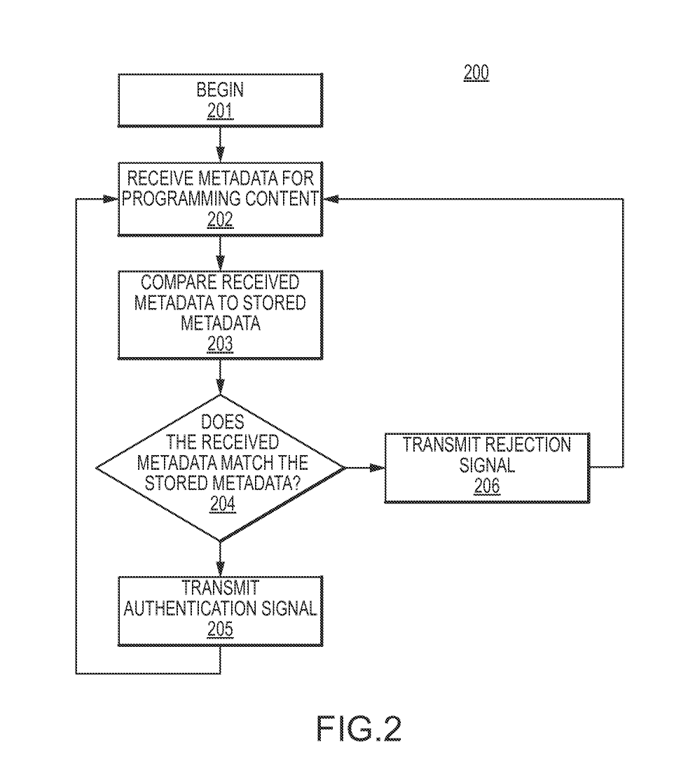

FIG. 2 illustrates one embodiment of a method 200 for metadata verification. The method 200 may be performed by the verification server 109 of FIG. 1. The flow begins at block 201 and proceeds to block 202 where the verification server 109 receives metadata for the programming content, which can be one or more television programs, movies, video on demand programs, images, audio, and so on. As discussed above, the metadata can be any data relating to the programming content, such as the duration of the content, the camera lenses used to capture the content, the name of the programming content, the creator of the content, and so on and so forth. In some embodiments, the verification server 109 may receive the content from the programming receiver 105. However, in other embodiments, the server 109 may receive the content from the content provider 113. As discussed above, in further embodiments, the verification server 109 may receive the programming content and may derive the metadata from the programming content using a recognition algorithm.

The flow then proceeds to block 203 where the verification server 109 may compare the received metadata to metadata corresponding to scheduled or upcoming programming content stored in a database. As discussed above, the database may be a relational database stored in the storage medium 152 of the server 109 or an external storage medium. The database may be a look-up table that links various programming content with corresponding metadata.

In block 204, the verification server 109 may determine whether the received metadata matches the metadata corresponding to the scheduled or upcoming programming content stored in the database. If, in block 204, the verification server determines that there is a match, then, in block 205, the verification server may transmit an authentication signal. In one embodiment, the authentication signal may be transmitted to the programming receiver 105. The flow then returns to block 202, in which the verification server 109 may receive metadata for additional programming content. If, in block 204, the verification server 109 determines that the received metadata does not match the metadata corresponding to the upcoming programming content stored in the database, then, in block 206, the verification server 109 may transmit a rejection signal to the programming receiver 105. The flow then returns to block 202, in which the verification server 109 may receive metadata for additional programming content.

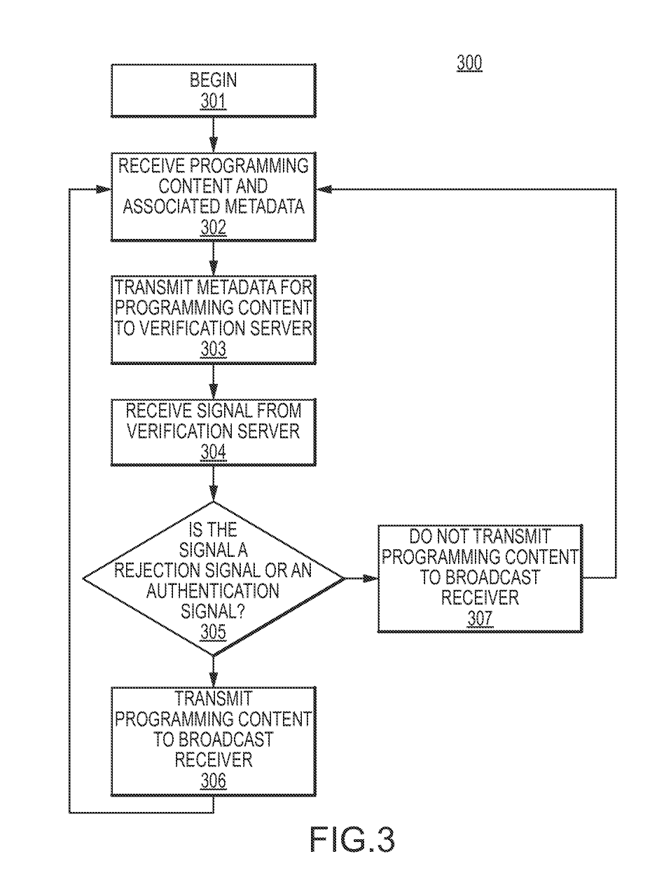

FIG. 3 illustrates another embodiment of a method 300 for metadata verification. The method 300 may be performed by the programming receiver 105 of FIG. 1. The flow begins at block 301 and proceeds to block 302, where the programming receiver 105 may receive programming content and metadata associated with the programming content from a content provider 113. The flow then proceeds to block 303, where the programming receiver 105 may transmit the metadata for the programming content to a verification server 109. The flow then proceeds to block 304, where the programming receiver 105 may receive a signal from the verification server 109. As discussed above, the signal may be a rejection signal signifying that the transmitted metadata does not match the metadata for a scheduled or upcoming program, or an authentication signal signifying that the transmitted metadata matches the metadata for a scheduled or upcoming program. The flow then proceeds to block 305, in which the programming receiver 105 may determine whether the signal received from the verification server 109 is a rejection or an authentication signal. If, in block 305, the programming receiver 105 determines that the signal received from the verification server 109 is an authentication signal, then, in block 306, the programming receiver 105 may transmit the programming content received in block 302 to a broadcast receiver 101. The flow then proceeds back to block 303, in which the programming receiver 105 may receive additional programming content and associated metadata from the content provider 113. If, in block 305, the programming receiver 105 determines that the signal received from the verification server 109 is a rejection signal, then, in block 307, the programming receiver 105 may not transmit the programming content received in block 302 to the broadcast receiver 101. The flow then proceeds back to block 303, in which the programming receiver 105 may receive additional programming content and associated metadata from the content provider 113.

Although the transmission media 107, 115, 111, and 119 are illustrated and described as separate transmission media, it should be understood that in various implementations the various transmission media may be implemented as a single transmission media connecting the various components in the system 100 and/or any number of configurations of one or more transmission media.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a: magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. A method for verifying metadata associated with programming content, the method comprising:
receiving a first metadatum corresponding to a first programming content;
comparing the first metadatum to at least one stored metadatum corresponding to the first programming content stored in a database;
determining whether the first metadatum matches the at least one stored metadatum stored in the database;
transmitting a first signal if the first metadatum matches the stored metadatum; and
transmitting a second signal, different from the first signal, if the first metadatum does not match the at least one stored metadatum.

2. The method of claim 1, wherein the first signal is configured to cause a programming receiver to transmit the first programming content to a broadcast receiver.

3. The method of claim 1, wherein the second signal is configured to cause a programming receiver to block transmission of the first programming content to a broadcast receiver.

4. The method of claim 1, wherein the first signal or the second signal is transmitted to a programming receiver.

5. The method of claim 1, wherein the first metadatum is received from a content provider.

6. The method of claim 1, wherein the first metadatum is received from a programming receiver.

7. A system configured to verify metadata associated with programming content, the system comprising:
a server comprising:
a communication component operable to receive a first metadatum corresponding to a first programming content;
a storage medium storing a database of at least one metadatum corresponding to at least one programming content; and
a processing unit coupled to the storage medium and the communication component, the processing unit configured to access the database stored in the storage medium to determine whether the first metadatum matches at least one of the at least one metadatum stored in the database.

8. The system of claim 7, wherein the database is a look-up table.

9. The system of claim 7, wherein the communication component is configured to transmit a first signal if the first metadatum matches at least one of the at least one metadatum stored in the database and to transmit a second signal different from the first signal if the first metadatum does not match at least one of the at least one metadatum stored in the database.

10. The system of claim 10, wherein the first signal is configured to cause a programming receiver to transmit the first programming content to a broadcast receiver.

11. The system of claim 10, wherein the second signal is configured to cause a programming receiver to block transmission of the first programming content to a broadcast receiver.

12. The system of claim 7, wherein the server is communicatively coupled to a content provider.

13. The system of claim 7, wherein the server is communicatively coupled to a programming receiver.

14. The system of claim 7, wherein the first metadatum is encrypted into a first encrypted signal carrying the first programming content.

15. The system of claim 14, wherein the processing unit is further configured to decrypt the first encrypted signal to derive the first metadatum.

16. The system of claim 7, further comprising a broadcast receiver configured to receive the first programming content from the server.

17. A method for authenticated broadcast of programming content, comprising:
receiving a first programming content and a first metadatum corresponding to the first programming content;
transmitting the first metadatum to a server;
receiving a signal from the server;
determining whether the received signal is a first type of signal or a second type of signal; and
either transmitting the first programming content if the received signal is the first type of signal; or
preventing transmission of the first programming content if the received signal is the second type of signal.

18. The method of claim 17, wherein the first programming content and the first metadatum are received from a content provider.

19. The method of claim 16, wherein the first metadatum is encrypted in a first encrypted signal comprising the first programming content and the first metadatum.

20. The method of claim 1, wherein the first metadatum is received from a content provider.
